(19) United States
(12) Patent Application Publication
(10) Pub. No.: US 2023/0402810 A1
(43) Pub. Date: Dec. 14, 2023

(54) A laser with two longitudinal modes at different wavelengths with orthogonal polarizations

(71) Applicant: Pavilion Integration Corporation, San Jose, CA (US)

(72) Inventors: Haiwen Wang, San Jose, CA (US); Ningyi Luo, San Jose, CA (US); Jihchuang Robin Huang, San Jose, CA (US)

(73) Assignee: Pavilion Integration Corporation, San Jose, CA (US)

(21) Appl. No.: 18/259,078

(22) PCT Filed: Mar. 7, 2023
(86) PCT No.: PCT/IB2023/052144

§ 371 Date: Jul. 17, 2023

Related U.S. Application Data
(60) Provisional application No. 63/324,059, filed on Mar. 26, 2022.

(51) Int. Cl. H01S 3/10; H01S 3/081; H01S 3/16; H01S 3/08; H01S 3/109

(52) U.S. Cl. CPC H01S 3/10053; H01S 3/0815; H01S 3/1603; H01S 3/08054; H01S 3/109

(57) ABSTRACT

The present invention provides a way to use anisotropic laser gain media to make a laser that can lase in two longitudinal modes at different wavelengths with orthogonal polarizations. The two longitudinal mode (LM) laser output can be separated to generate two single LM outputs. This type of lasers can also be used to generate low noise continuous wave (CW) harmonics through intracavity harmonic generation.

### BACKGROUND OF THE INVENTION

There are laser applications in many fields from biomedical and semiconductor to defense industries. Different wavelengths are required for different applications. Some required wavelengths are hard to obtain by direct laser emission. One of the methods to extend laser wavelength range is through harmonic generation. Some applications also require single longitudinal-mode (“LM”) lasers.

In order to obtain a single LM laser, a mode selection element, such as an etalon, a Lyot filter etc. is commonly used to make the laser run in only one LM. However, it is not easy to run in single LM with a standing wave cavity because of spatial hole burning. One method to remove spatial hole burning is the twisted mode method (V. Evtuhov and A. Siegman, “A ‘twisted-mode’ technique for obtaining axially uniform energy density in a laser cavity”, Appl. Opt., Vol. 4, pp. 142, 1965). It applies to isotropic laser gain media such as Nd:YAG. Y. Ma et al. extended it to anisotropic laser gain media that can lase at the same wavelength with orthogonal polarizations and significantly reduced the spatial hole burning (Y. Ma, et al., U.S. Pat. No. 7,742,509 B2, 2010).

There are two ways to generate harmonics of a laser, i.e., intracavity and extracavity harmonic generations. Intracavity harmonic generation is usually more efficient because intracavity fundamental beam intensity is much higher than the laser output. However, it is not easy to generate low noise CW intracavity harmonics because of the “green noise” problem first discovered by Baer (T. M. Baer, “Large-amplitude fluctuations due to longitudinal mode coupling in diode-pumped intracavity-doubled Nd:YAG lasers”, JOSA B, Vol. 3, pp. 1175, 1986). There have been some ways to solve the “green noise” problem, such as single LM method, multi-LM (>10 modes) method (W. L. Nighan, et al., U.S. Pat. No. 5,446,749, 1995), and orthogonal polarization method (L. Y. Liu, et al., “Longitudinally diode-pumped continuous-wave 3.5-W green laser”, Opt. Lett., Vol. 19, pp. 189, 1994, “Liu Reference”). This orthogonal polarization method requires that the laser gain medium can lase at the same or very close wavelength(s) with orthogonal polarizations.

The present invention provides a laser that can lase with orthogonal polarizations in two LMs at wavelengths that are not close. It can be used to generate low noise CW harmonic(s) through intracavity harmonic generation of either LM or both LMs. The two fundamental wavelength outputs can also be separated to generate two single longitudinal mode laser outputs.

### SUMMARY OF THE INVENTION

Spatial hole burning affects the performance of single LM operation in a standing wave cavity laser. If a laser run in two LMs with orthogonal polarizations and the nodes of one LM is aligned with the antinodes of the other LM, the spatial hole burning is eliminated or significantly reduced. This requires that the wavelengths of the two LMs are the same or very close. However, some anisotropic laser gain media don't lase at the same or very close wavelength(s) with orthogonal polarizations. The present invention cuts the anisotropic laser gain media at a special orientation so that the wavelengths of the two LMs with orthogonal polarizations are the same or very close inside the laser gain media although they are not the same in the air. This invention also makes the two LMs to have a phase difference of odd multiples of π/4 inside the laser gain media so that the nodes of one LM align with antinodes of the other LM inside the laser gain medium.

If a single LM output is preferred, the two LMs with orthogonal polarizations can be separated to generate two single longitudinal mode outputs.

If the harmonic output is preferred, a nonlinear optic or optics can be inserted into this laser cavity to generate the harmonic(s) of either mode or both modes simultaneously and avoid the “green noise” problem.

### DESCRIPTION OF THE DRAWING

The invention will be described with respect to a drawing in several figures.

FIG. 1 shows an anisotropic laser gain medium together with other elements.

FIG. 2 shows how to make different wavelengths in air the same inside an anisotropic laser gain medium.

FIG. 3 shows a medium cut to a special orientation.

FIG. 4 shows an arrangement accomplishing a phase difference of odd multiples of quarter-wave, or close to it, between two LMs inside a laser gain medium.

FIG. 5 shows a first arrangement to realize a quarter-wave phase difference.

FIG. 6 shows a second arrangement to realize a quarter-wave phase difference.

FIG. 7 shows an arrangement in which the two LM outputs of a laser can be separated and two single LM outputs can be obtained.

FIG. 8 shows an arrangement by which a second harmonic of λ1 is generated with type-I phase matching.

FIG. 9 an arrangement by which low-noise CW intracavity SHG with type II phase matching can be accomplished.

FIG. 10 shows an arrangement by which low-noise CW intracavity SHG of both λ1 and λ2 can be realized simultaneously.

FIG. 11 shows an arrangement for separating two second harmonics into two single LM outputs.

FIG. 12 shows an arrangement for giving rise to low-noise CW intracavity third harmonic generation (THG).

FIG. 13 shows an example of low noise CW intracavity second harmonic generation (SHG) with a monolithic structure.

### DETAILED DESCRIPTION OF EXEMPLARY EMBODIMENTS

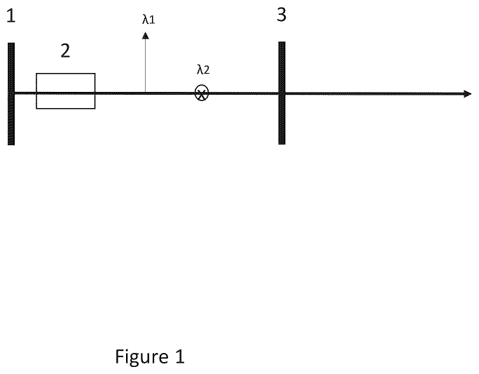

Some anisotropic laser gain media can emit at orthogonal polarizations. The emission peaks and stimulated emission cross-sections are usually different in different polarizations. Item 2 in FIG. 1 is such an anisotropic laser gain medium. Item 1 is a high reflector and item 3 is the output coupler. They thus form a standing wave cavity. The arrow line extending rightwards in FIG. 1 represents the laser beam. (The pump source and scheme for item 2 is omitted for clarity in FIG. 1 because the present invention applies to all pump sources and schemes.) Item 2 can emit lights of wavelengths λ₁ and λ₂, in orthogonal polarizations. Here it is assumed that the stimulated emission cross-section of λ₁ is larger than that of λ₂. This type of laser usually only lases in the polarization that has a higher stimulated emission cross-section. It also lases in multi-LM because of spatial hole burning.

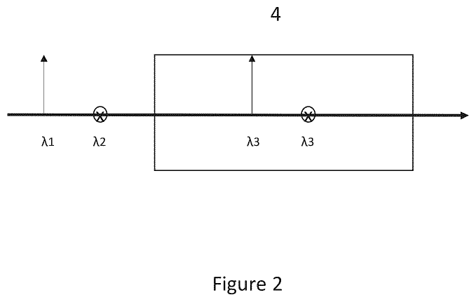

FIG. 2 illustrates how to make the different wavelengths with orthogonal polarizations the same inside an anisotropic laser gain medium. If the anisotropic laser gain medium item 4 is cut in such a way that satisfies equation 1,

λ₂/n₁=λ₂/n₂ (1)

where n₁ and n₂ are refractive indices of λ₁ and λ₂ inside item 4, respectively, then the wavelengths of both lights would be the same inside item 4, labeled as λ₃ in FIG. 2. The arrow line extending rightwards in FIG. 2 represents the laser beam. It is then possible to align nodes of one LM with antinodes of the other LM and to extract all gains and eliminate or significantly reduce spatial hole burning with 2 LMs.

The laser gain medium may be selected from the set consisting of praseodymium doped YLF, praseodymium doped LLF, praseodymium doped GLF, praseodymium doped YAP, praseodymium doped SRA, neodymium doped YLF, ytterbium doped YLF, erbium doped YLF, thulium doped YLF, holmium doped YLF, neodymium doped vanadate, ytterbium doped vanadate, erbium doped vanadate, thulium doped vanadate, and holmium doped vanadate.

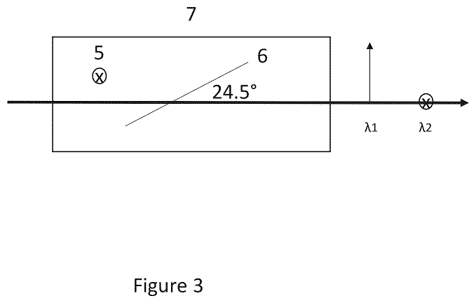

FIG. 3 shows, as an example, a Pr:YLF (item 7) cut to a special orientation. 5 is the a-axis direction, which is perpendicular to the paper plane depicted in FIG. 3. 6 is the c-axis direction, which is in the paper plane depicted in FIG. 3. The arrow line extending rightwards in FIG. 3 represents the laser beam. The wavelength λ₁ of the LM polarized in the paper plane is 697.6 nm in air, while the wavelength λ₂ of the LM polarized perpendicular to the paper plane is 695.8 nm in air. The result because of the special orientation of the cut is that the two wavelengths are the same or very close to the same inside the Pr:YLF, although they are different in air.

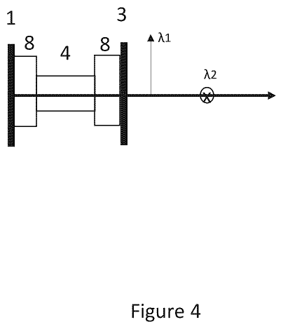

Another requirement for the nodes of one LM to be aligned with antinodes of the other LM inside the laser gain medium is that there is a phase difference of odd multiples of quarter wave, or close to it, between the two LMs inside the laser gain medium. FIG. 4 illustrates such a laser. Item 1 is a high reflector and item 3 is the output coupler. They thus form a standing wave cavity. The arrow line extending rightwards in FIG. 4 represents the laser beam. Item 4 is the laser gain medium with special orientation illustrated in FIG. 2. (The pump source and scheme for item 4 are omitted for clarity in FIG. 4 because the present invention applies to all pump sources and schemes.) The LM with wavelength λ₁ in air is polarized in the paper plane depicted in FIG. 4 while the LM with wavelength λ₂ in air is polarized perpendicular to the paper plane depicted in FIG. 4. Item 8 is a mechanism that introduces odd multiples of quarter wave phase difference between the two LMs. The nodes of one LM align with antinodes of the other LM inside item 4. The laser runs in two longitudinal modes at different wavelengths in air with orthogonal polarizations.

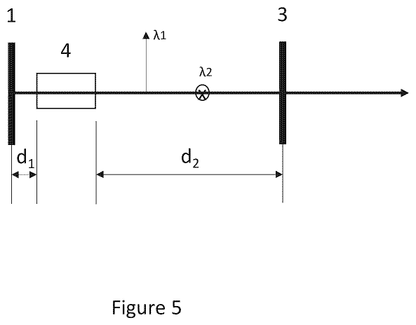

There are many ways to realize the quarter wave phase difference. FIG. 5 shows another example in addition to the example of FIG. 4. Item 1 is a high reflector and item 3 is the output coupler. They thus form a standing wave cavity. The arrow line extending rightwards in FIG. 5 represents the laser beam. Item 4 is the laser gain medium with special orientation illustrated in FIG. 2. (The pump source and scheme for item 4 are omitted for clarity in FIG. 5 because the present invention applies to all pump sources and schemes.) The LM with wavelength λ₁ in air is polarized in the paper plane depicted in FIG. 5 while the LM with wavelength λ₂ in air is polarized perpendicular the paper plane depicted in FIG. 5. d₁ is the optical path length between item 1 and the surface of item 4 that is proximal to item 1. d₂ is the optical path length between item 3 and the surface of item 4 that is proximal to item 3. If each of d₁ and d₂ satisfy equation 2,

$$d = \frac{m λ 1 λ 2}{4 \vert λ 1 - λ 2 \vert} \qquad ( 2 )$$

where m is an odd integer, it would introduce a phase difference of odd multiples of quarter wave between the two LMs inside item 4.

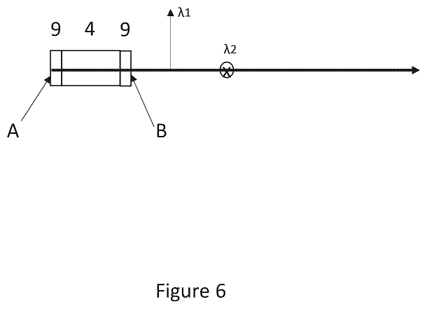

The present invention can also be realized with a monolithic structure. FIG. 6 shows such an example. Item 9 is a waveplate that introduces an odd multiple of quarter wave phase difference between the two LMs. Surface A is a highly reflective for both LMs and serves as one end mirror. Surface B is coated as an output coupler. Surfaces A and B thus form a standing wave cavity. The arrow line extending rightwards in FIG. 6 represents the laser beam. Item 4 is the laser gain medium with special orientation illustrated in FIG. 2. (The pump source and scheme for item 4 are omitted for clarity in FIG. 6 because the present invention applies to all pump sources and schemes.) The LM with wavelength λ₁ in air is polarized in the paper plane depicted in FIG. 6 while the LM with wavelength λ₂ in air is polarized perpendicular to the paper plane depicted in FIG. 6. Item 4 and the two item 9's are held together with no adhesive bonding or other methods.

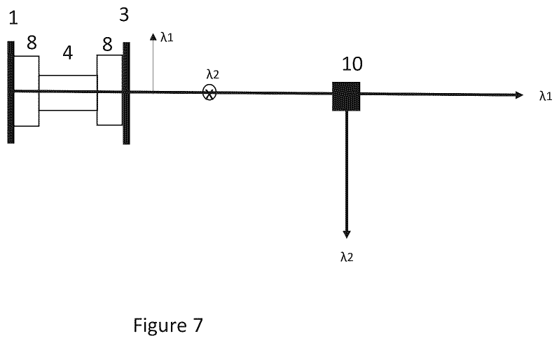

The two LM output of such a laser can be separated and two single LM output can be obtained as illustrated in FIG. 7. Item 10 is the element that separates the two LMs. For example, item 10 can be a polarizer. The rest are the same as in FIG. 4.

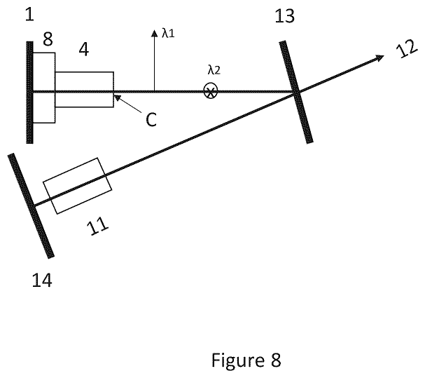

This laser can also be used for low noise CW intracavity second harmonic generation (SHG) with type I phase matching. FIG. 8 illustrates an example of the generation of the second harmonic of λ₁ with type I phase matching. Item 1 is a high reflector for λ₁ and λ₂. Item 14 a high reflector for λ₁, λ₂ and the second harmonic of λ₁. Item 13 is highly reflective to λ₁ and λ₂ and is highly transmissive to the second harmonic of λ₁. Items 1, 13, and 14 thus form a standing wave cavity. Item 4 is the laser gain medium with special orientation illustrated in FIG. 2. (The pump source and scheme for item 4 are omitted for clarity in FIG. 8 because the present invention applies to all pump sources and schemes.) The LM with wavelength λ₁ in air is polarized in the paper plane depicted in FIG. 8 while the LM with wavelength λ₂ in air is polarized perpendicular to the paper plane depicted in FIG. 8. Item 8 is a mechanism that introduces odd multiples of quarter wave phase difference between the two LMs. The phase difference between the two LMs is odd multiples of quarter wave along the optical path between surface C and item 14. Item 11 is a type I SHG optic for λ₁. Item 12 is the second harmonic output. The polarization of λ₂ is orthogonal to λ₁ and hence there is no nonlinear interaction between the LM of λ₂ and item 11. This intracavity SHG is equivalent to that of a single LM laser at wavelength λ₁. The same method applies to intracavity SHG of λ₂ with type I phase matching.

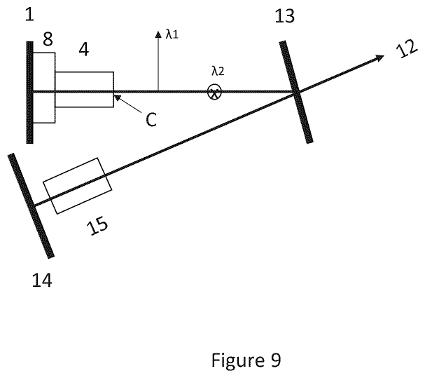

This laser can also be used for low noise CW intracavity SHG with type II phase matching. An example of which is illustrated in FIG. 9 by replacing item 11 in FIG. 8 with a type II phase matching SHG optic (item 15) for wavelength λ₁. The double pass phase difference between the ordinary light and extraordinary light of item 15 is at or close to full wave for both λ₁ and λ₂. The acceptance bandwidth of item 15 is selected to be not wide enough to cover wavelength λ₂. (The case that the acceptance bandwidth of item 15 is wide enough to cover both λ₁ and λ₂ will be discussed separately below.) Therefore, the LM λ₂ has no nonlinear interaction with item 15. This intracavity SHG is equivalent to that of a single LM laser at wavelength λ₁. The same method applies to intracavity SHG of λ₂ with type II phase matching where the acceptance bandwidth is not wide enough to cover both λ₁ and λ₂.

The nonlinear optic may be selected from the group consisting of BBO, LBO, CLBO, KBBF, BiBO, KTP, KD*P, PPLN, PPSLT, and PP-LBGO.

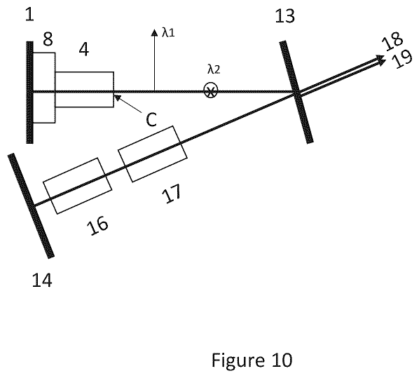

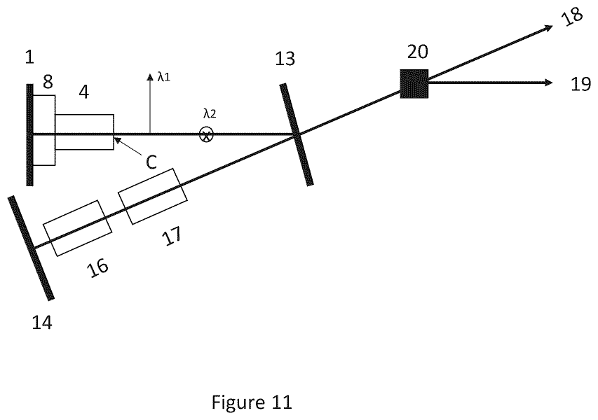

Low noise CW intracavity SHG of both λ₁ and λ₂ can also be realized simultaneously with the present invention. An example is shown in FIG. 10. Item 1 is a high reflector for λ₁ and λ₂. Item 14 is a high reflector for λ₁, λ₂ and their second harmonics. Item 13 is highly reflective to λ₁, λ₂ and is highly transmissive to their second harmonics. Items 1, 13, and 14 thus form a standing wave cavity. Item 4 is the laser gain medium with special orientation illustrated in FIG. 2. (The pump source and scheme for item 4 are omitted for clarity in FIG. 10 because the present invention applies to all pump sources and schemes.) The LM with wavelength λ₁ in air is polarized in the paper plane depicted in FIG. 10 while the LM with wavelength λ₂ in air is polarized perpendicular to the paper plane depicted in FIG. 10. Item 8 is a mechanism that introduces odd multiples of quarter wave phase difference between the two LMs. The phase difference between the two LMs is odd multiples of quarter wave along the optical path between surface C and item 14. Item 16 is the SHG optic for either λ₁ or λ₂ while item 17 is the SHG optic for the other wavelength. Item 16 can be either type I or type II phase matching as illustrated in the paragraphs above. So is item 17. Items 18 and 19 are the two second harmonics generated. The two second harmonics can be separated to two single LM outputs as shown in FIG. 11 as an example. Item 20 is the beam separating element. For example, a polarizer can be used for this purpose.

If the type II phase matching SHG optic acceptance bandwidth is wide enough to cover both wavelengths of the two LMs, a method similar to the one described in the Liu Reference above can be used to generate low noise second harmonics of both LMs simultaneously.

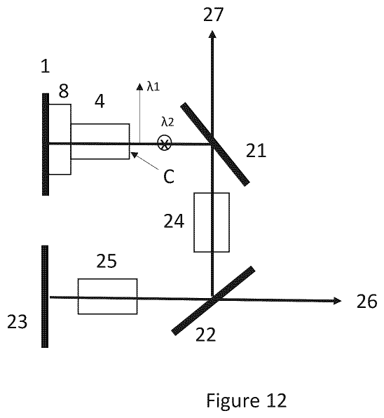

This laser can also be used for low noise CW intracavity third harmonic generation (THG). An example is illustrated in FIG. 12. Item 1 is a high reflector for λ₁ and λ₂. Item 21 is highly reflective to λ₁, λ₂, and is highly transmissive to the second harmonic of λ₁. Item 22 is highly reflective to λ₁, λ₂, and is highly reflective to the second harmonic of λ₁, and is highly transmissive to the third harmonic of λ₁. Item 23 is a high reflector for λ₁, λ₂, and the second and third harmonics of λ₁. Items 1, 21, 22, and 23 thus form a standing wave cavity. Item 4 is the laser gain medium with special orientation illustrated in FIG. 2. (The pump source and scheme for item 4 are omitted for clarity in FIG. 12 because the present invention applies to all pump sources and schemes.) The LM with wavelength λ₁ in air is polarized in the paper plane depicted in FIG. 12 while the LM with wavelength λ₂ in air is polarized perpendicular to the paper plane depicted in FIG. 12. Item 8 is a mechanism that introduces odd multiples of quarter wave phase difference between the two LMs in item 4. The phase difference between the two LMs is odd multiples of quarter wave along the optical path between surface C and item 23. Item 24 is a type I phase matching SHG optic for wavelength λ₁. Item 25 is a type II sum frequency generation optic for wavelength λ₁ and its second harmonic. Item 26 is the third harmonic generated by item 25. The residual second harmonic of λ₁ (item 27) is dumped out through item 21.

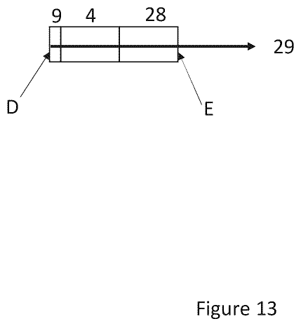

Monolithic structures can also be used for harmonic generations. FIG. 13 shows an example of low noise CW intracavity second harmonic generation (SHG) with type I phase matching. Surface D is highly reflective for λ₁, λ₂, and is highly reflective for the second harmonic of λ₁. Surface E is highly reflective to λ₁ and λ₂, and is highly transmissive to the second harmonic of λ₁. Surfaces D and E thus form a standing wave cavity. Item 4 is the laser gain medium with special orientation illustrated in FIG. 2. (The pump source and scheme for item 4 are omitted for clarity in FIG. 13 because the present invention applies to all pump sources and schemes.) The LM with wavelength λ₁ in air is polarized in the paper plane depicted in FIG. 13 while the LM with wavelength λ₂ in air is polarized perpendicular to the paper plane depicted in FIG. 13. Item 9 is a waveplate that introduces an odd multiple of quarter wave phase difference between the two LMs. Item 28 is a type I SHG optic for λ₁. The phase difference introduced by item 28 between the two LMs is odd multiples of quarter wave. Item 29 is the second harmonic output. Items 4, 9 and 28 are held together with no adhesive bonding or other methods.

There is walkoff between the two LMs if at least one of them is extraordinary wave. Their beam paths are not completely overlapped. If the pump method is colinear pumping, the pump polarization component that aligns with the polarization of one of the two LMs follows its beam path closely. The pump polarization component that aligns with the polarization of the other LM will follow the other beam path closely. Thus, we can adjust the relative power of the two LMs by controlling the polarization of the pump beam and effectively adjusting the relative pump power for each LM. For example, it is possible to use a half-wave plate at the pump wavelength to change the polarization direction of the pump or simply rotate the pump source.

The alert reader will have no difficulty devising various obvious variants and improvements upon the invention as described herein, all of which are intended to be encompassed within the claims which follow.

1. A laser that lases in two longitudinal modes at different wavelengths in air, with orthogonal polarizations, the laser comprising:
an anisotropic laser gain medium that is cut such that the wavelengths of the two longitudinal modes are equal or close to equal inside the laser gain medium, and
an element that introduces odd multiples of quarter-wave phase difference between the two longitudinal modes inside the laser gain medium.

2. The laser of claim 1, wherein the laser gain medium selected from the set consisting of praseodymium doped YLF, praseodymium doped LLF, praseodymium doped GLF, praseodymium doped YAP, praseodymium doped SRA, neodymium doped YLF, ytterbium doped YLF, erbium doped YLF, thulium doped YLF, holmium doped YLF, neodymium doped vanadate, ytterbium doped vanadate, erbium doped vanadate, thulium doped vanadate, and holmium doped vanadate.

3. The laser of claim 1, wherein there is a distance between an end mirror and a proximal surface of the laser gain medium, and wherein the element that introduces odd multiples of quarter-wave phase difference between the two longitudinal modes λ₁ and λ₂ inside the laser gain medium is realized by making the d distance between the end mirror and the proximal surface of the laser gain medium satisfy, or be close to satisfying, the equation:
$$d = \frac{m λ 1 λ 2}{4 \vert λ 1 - λ 2 \vert}$$
where m is an odd integer.

4. The laser of claim 1, wherein the mechanism that introduces odd multiples of quarter-wave phase difference between the two longitudinal modes inside the laser gain medium is use of a waveplate designed to introduce the phase difference.

5. The laser of claim 1, wherein the laser is monolithic.

6. The laser of claim 1, wherein the pump method is colinear pumping and the relative power of the two LMs is adjusted by controlling the polarization of the pump beam.

7. The laser of claim 1, further comprising a beam separating element inserted into an output of the laser to separate the two longitudinal modes, thereby obtaining two outputs, each being a single longitudinal mode output.

8. The laser of claim 7 wherein the beam separating element is a polarizer.

9. The laser of claim 1 wherein the laser defines a cavity, and wherein at least one nonlinear optic is within the cavity, whereby the laser is a low-noise CW intracavity harmonic generation laser.

10. The laser of claim 9, wherein the harmonic generation is second harmonic generation.

11. The laser of claim 10, wherein the at least one nonlinear optic is selected to give rise to type-I phase matching.

12. The laser of claim 10, wherein the at least one nonlinear optic is selected to give rise to type-II phase matching.

13. The laser of claim 10, wherein the second-harmonic generation takes place only for one longitudinal mode.

14. The laser of claim 10, wherein the second-harmonic generation takes place for both longitudinal modes.

15. The laser of claim 10, wherein the nonlinear optic(s) is selected from the set consisting of BBO, LBO, CLBO, KBBF, BiBO, KTP, KD*P, PPLN, PPSLT, and PP-LBGO.

16. The laser of claim 9, wherein the harmonic generation is third harmonic generation.

17. The laser of claim 16, wherein the third-harmonic generation is for one longitudinal mode only.

18. The laser of claim 16, wherein the third-harmonic generation is for both longitudinal modes.

19. The laser of claim 16, wherein the nonlinear optics is selected from the set consisting of BBO, LBO, CLBO, KBBF, BiBO, KTP, KD*P, PPLN, PPSLT, and PP-LBGO.

20. The laser of claim 8 wherein the laser is monolithic.

21. The laser of claim 9, wherein the pump method is colinear pumping and the relative power of the two LMs is adjusted by controlling the polarization of the pump beam.

22. A method for use in lasing with respect to two longitudinal modes at differing in respective wavelengths in air, the method carried out with respect to a laser comprising:
an anisotropic laser gain medium that is cut such that the wavelengths of the two longitudinal modes are equal or close to equal inside the laser gain medium, and
an element that introduces odd multiples of quarter-wave phase difference between the two longitudinal modes inside the laser gain medium;
the method comprising providing stimulation thereto, whereby lasing occurs.

23. The method of claim 22, carried out with respect to a beam-separating element inserted into an output of the laser, whereby two outputs are obtained, each being a single longitudinal mode output.
